(19) United States
(12) Patent Application Publication
(10) Pub. No.: US 2022/0196348 A1
(43) Pub. Date: Jun. 23, 2022

(54) SUPPORT AND CONNECTION DEVICE

(71) Applicant: UFI FILTERS S.P.A., Porto Mantovano, Mantova (IT)

(72) Inventor: Giorgio GIRONDI, Porto Mantovano, Mantova (IT)

(21) Appl. No.: 17/604,901

(22) PCT Filed: Apr. 16, 2020
(86) PCT No.: PCT/IB2020/053595

§ 371 Date: Oct. 19, 2021

(30) Foreign Application Priority Data
Apr. 19, 2019 (IT) 102019000006182

(51) Int. Cl. F28F 9/02; F01P 3/18; F01P 5/10; F28D 9/00

(52) U.S. Cl. CPC F28F 9/0253; F01P 3/18; F01P 5/10; F01P 2003/006; F28F 9/0221; F28F 9/0229; F28D 9/005

(57) ABSTRACT

A support and connection device is for an operating group of a vehicle. The support and connection device is configured for supporting and for fluidic connection with an operating device in turn included in the operating group. The support and connection device identifies a vertical axis and two longitudinal axes and includes at least one plate-shaped unit in which, in the vertical direction, there is at least one mouth for the passage of a working fluid. The plate-shaped unit includes an upper laminar element, a lower laminar element reciprocally stacked along the vertical axis and a hollow space between them. The at least one mouth for fluid passage is defined laterally by a fluid mouth wall constituted by the reciprocal engagement of an upper mouth rim included in the upper laminar element and by a lower mouth rim included in the lower laminar element.

### FIELD OF APPLICATION

The present invention regards a support and connection device for an operating group of a vehicle. In addition, the present invention also regards an operating group which includes said support and connection device.

In particular, the present invention is intended for the automotive sector.

In fact, such operating groups are well known in the automotive sector, in which “operating group” means a component or group of components suitable for fluidic connection with specific circuits of the vehicle to carry out certain operations, for example heat regulation, filtering etc. The operating group is therefore suitable for fluidic connection to one or more fluidic circuits, for example vehicle oil or water.

### STATE OF THE ART

In the state of the art it is well known that a vehicle includes one or more operating groups. Usually the well-known operating groups are installable in the vehicle in a predefined position, preferably mounted on engine groups, transmission groups, gearshift groups in such a way as to be close to these components in fluidic terms.

The well-known solutions of operating groups include operating devices specifically suitable for carrying out their operations on the respective working fluids, and include support and connection devices whose purpose is to support and provide fluidic connection of said operating devices to the vehicle (and in particular to the abovementioned engine groups, transmission groups, gearshift groups).

In the state of the art there are well known solutions of support and connection devices consisting of single integral bodies specially designed to be mounted on respective vehicle groups and suitable for supporting and connecting (through fluid conduits present within them) the operating devices.

These solutions of support and connection devices however have particularly complex geometries and layouts and are of particularly complex production, as well as having considerable bulk and weight.

Equally well known are support and connection devices which instead of being single integral bodies are constituted by stacking a series of planar elements of constant thickness.

Although these embodiments are more versatile, resolving at least in part the problem related to the production of complex geometries and layouts, they continue, nevertheless, to be bulky and above all heavy.

For example, some embodiments of support and connection devices are shown in document U.S. Pat. No. 7,225,785.

### SOLUTION OF THE INVENTION

The need is therefore greatly felt to provide a support and connection device that resolves the above problems.

The purpose of the present invention is to supply a support and connection device whose weight and possibly, bulk, is as reduced as possible.

This purpose is achieved by the support and connection device claimed in claim 1. In addition, the purpose is also achieved by an operating group according to claim 19 and by an operating group according to claim 20. The claims dependent on these show preferred embodiments involving further advantageous aspects.

### DESCRIPTION OF THE DRAWINGS

Further features and advantages of the invention will be seen from the description below of the preferred embodiment examples, made by way of non-limiting example, with reference to the annexed figures in which:

FIG. 1 shows a perspective view in separate parts of an operating group as per this invention, in accordance with a preferred embodiment including a support and connection device, which is in turn the subject of this invention, in accordance with a first preferred embodiment;

FIG. 2 represents a lateral view of the operating group of FIG. 1;

FIGS. 2a, 2b and 2c show respectively a view from above, a view from below and a view in planar section of the support and connection device included in the operating group as per FIG. 2;

FIG. 3 represents a view from above of the operating group as per FIG. 1;

FIGS. 3a, 3b, 3c and 3d illustrate respectively a view in section along the plane of section A-A of FIG. 3, a view in section along the plane of section B-B of FIG. 3, a view in section along the plane of section C-C of FIG. 3 and a view in section along the plane of section D-D of FIG. 3;

FIGS. 3a′, 3b′, 3c′ and 3d′ show some enlarged views of FIGS. 3a, 3b, 3c and 3d;

FIG. 4 shows a perspective view in separate parts of an operating group as per this invention, in accordance with a preferred embodiment including a support and connection device, which is in turn the subject of this invention, in accordance with a further preferred embodiment;

FIG. 5 represents a lateral view of the operating group as per FIG. 4;

FIGS. 5a, 5b and 5c show respectively a view from above, a view from below and a view in planar section of the support and connection device included in the operating group as per FIG. 5;

FIG. 6 represents a view from above of the operating group as per FIG. 1;

FIGS. 6a, 6b, 6c and 6d illustrate respectively a view in section along the plane of section A-A of FIG. 6, a view in section along the plane of section B-B of FIG. 6, a view in section along the plane of section C-C of FIG. 6 and a view in section along the plane of section D-D of FIG. 6;

FIGS. 6a′, 6b′, 6c′ and 6d′ show some enlarged views of FIGS. 6a, 6b, 6c and 6d.

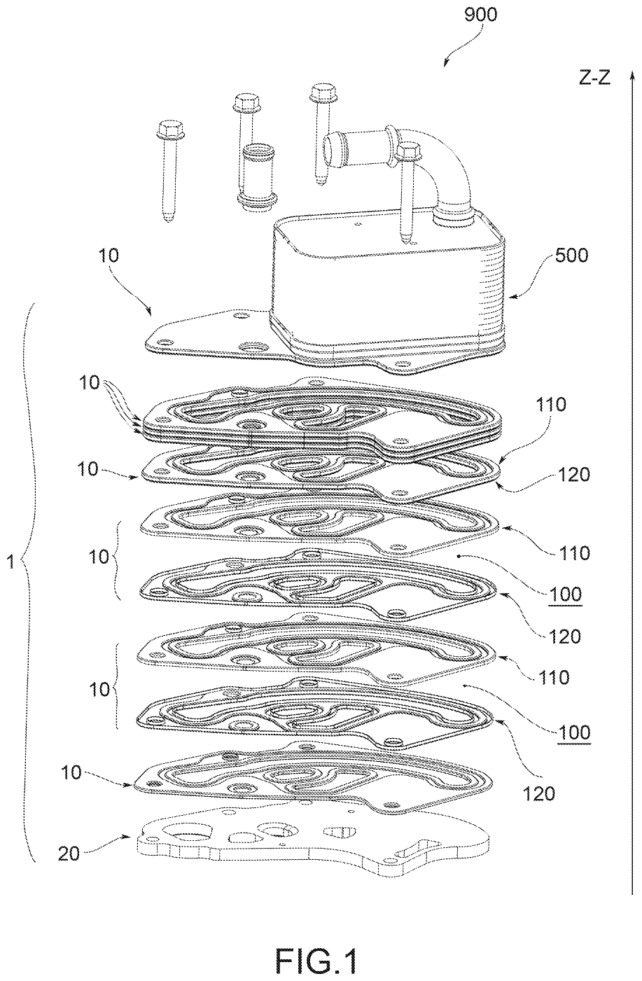

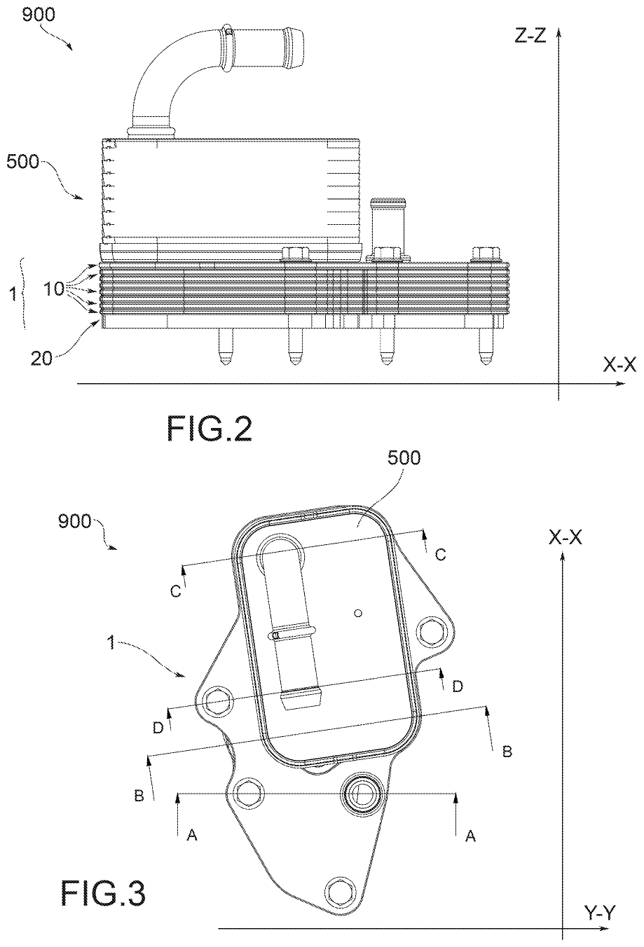

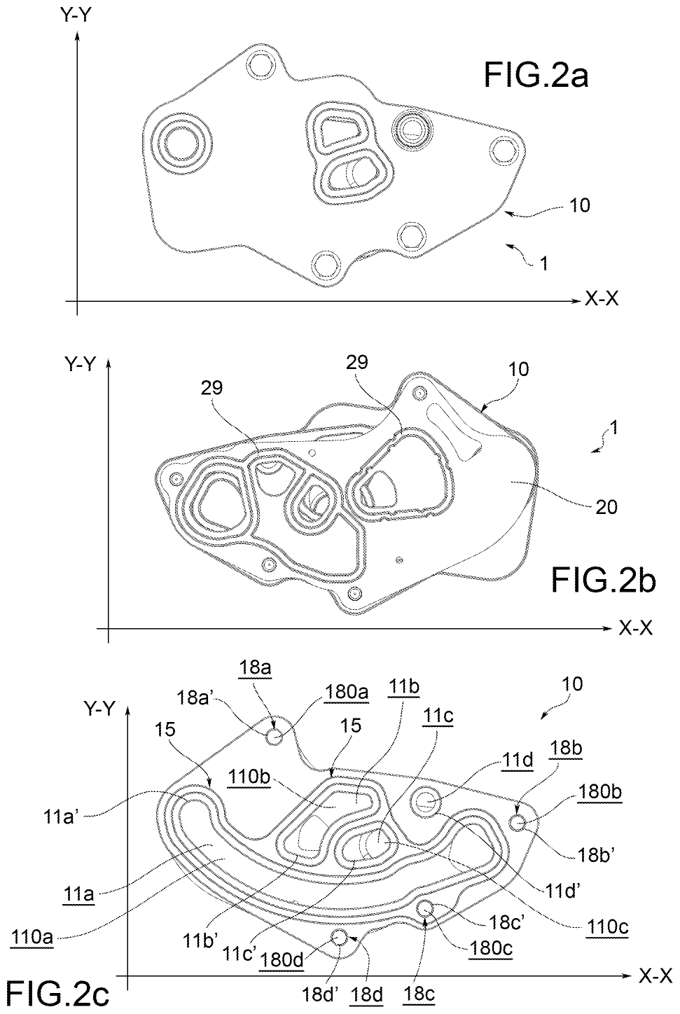

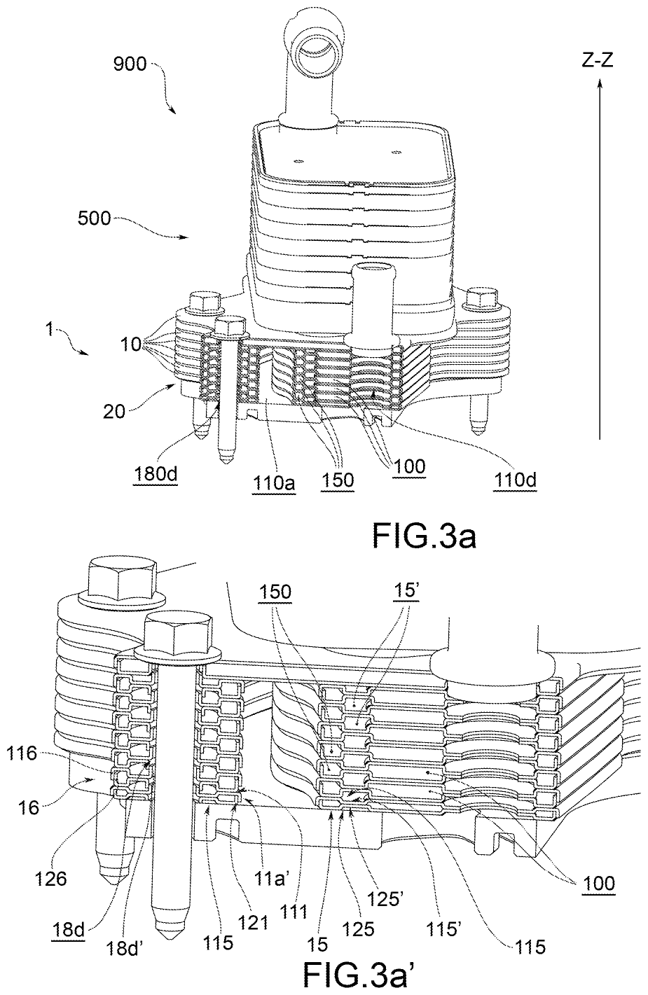

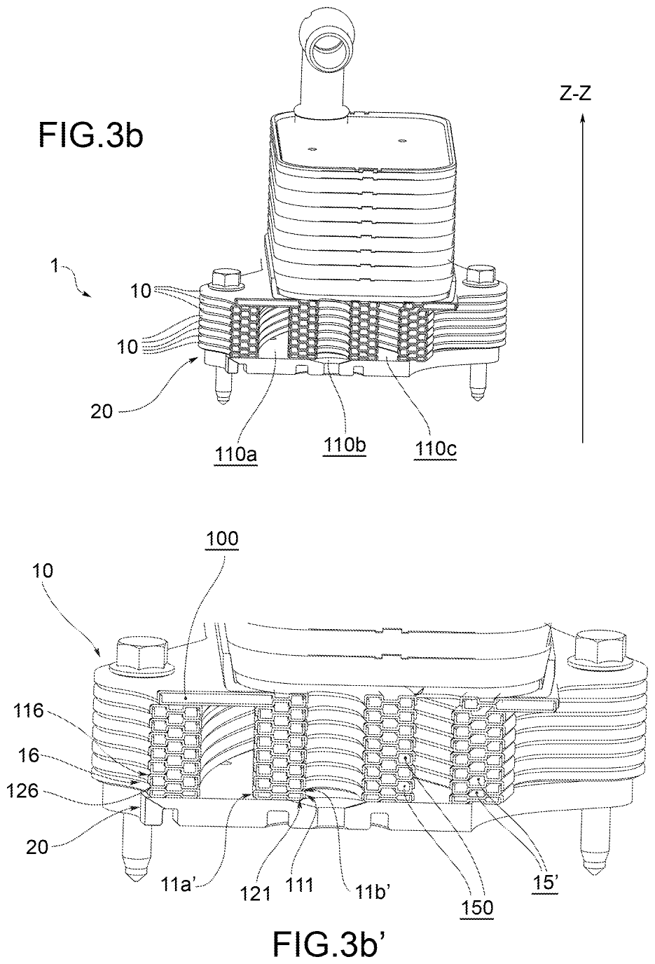

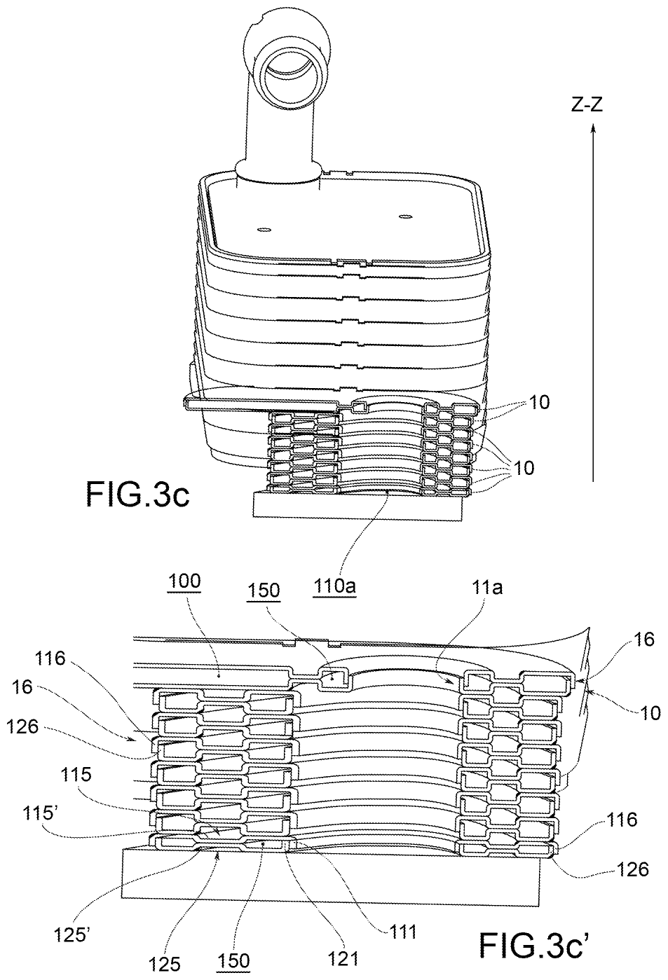

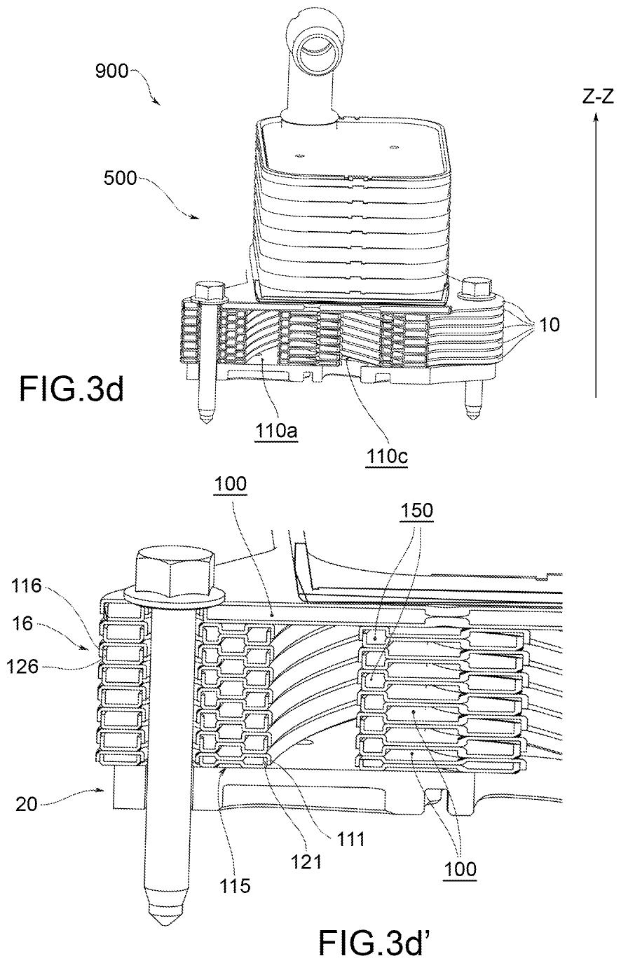

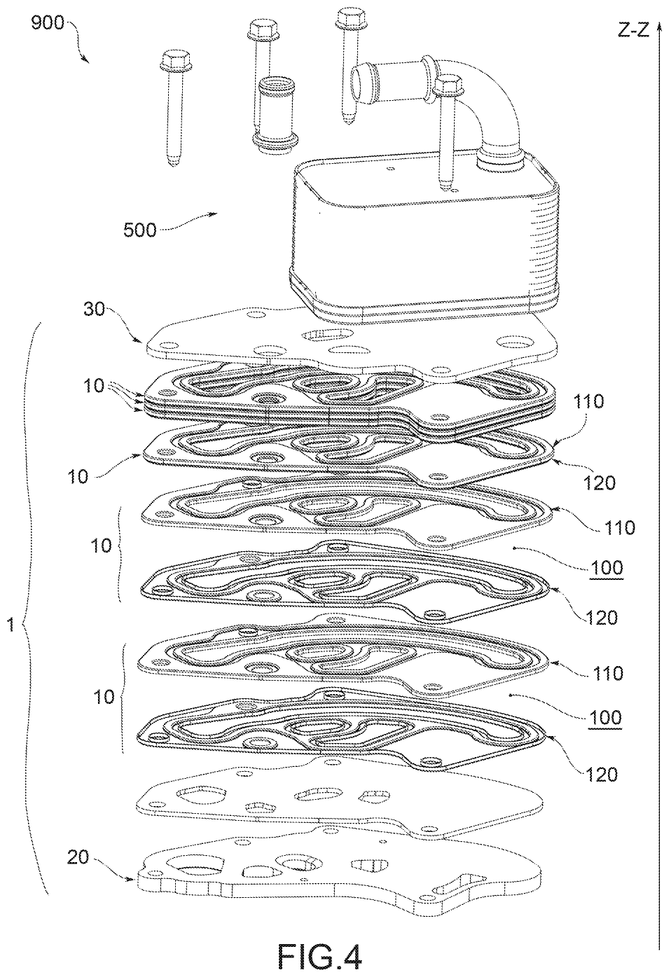

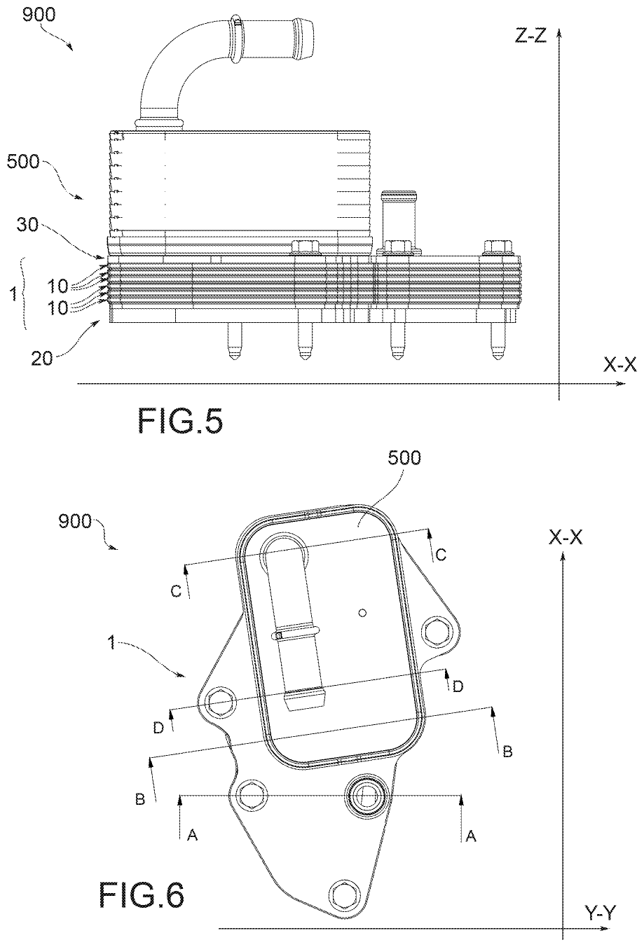

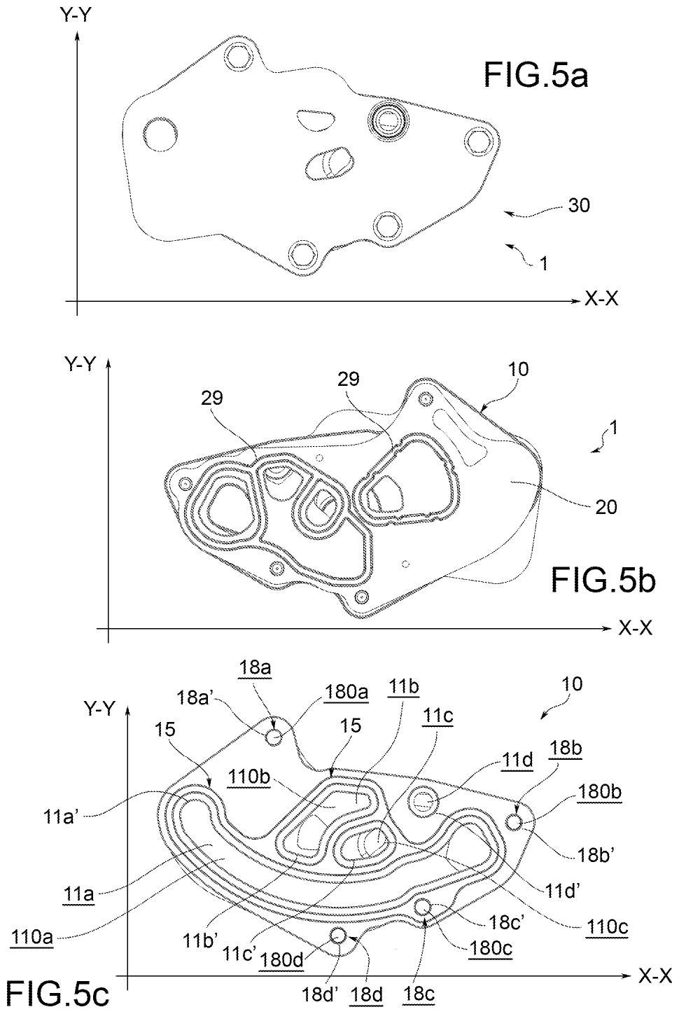

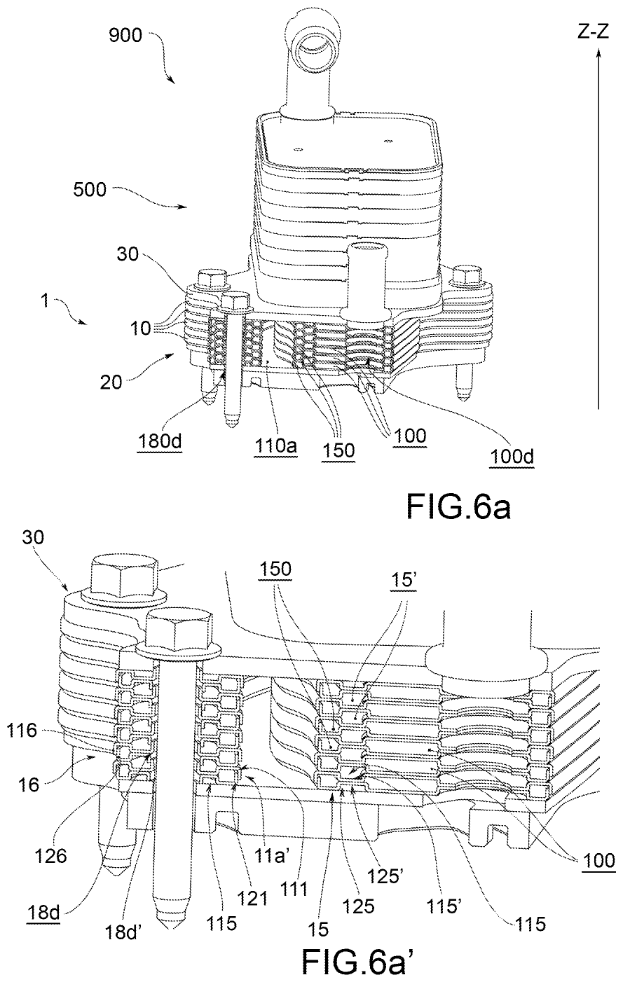

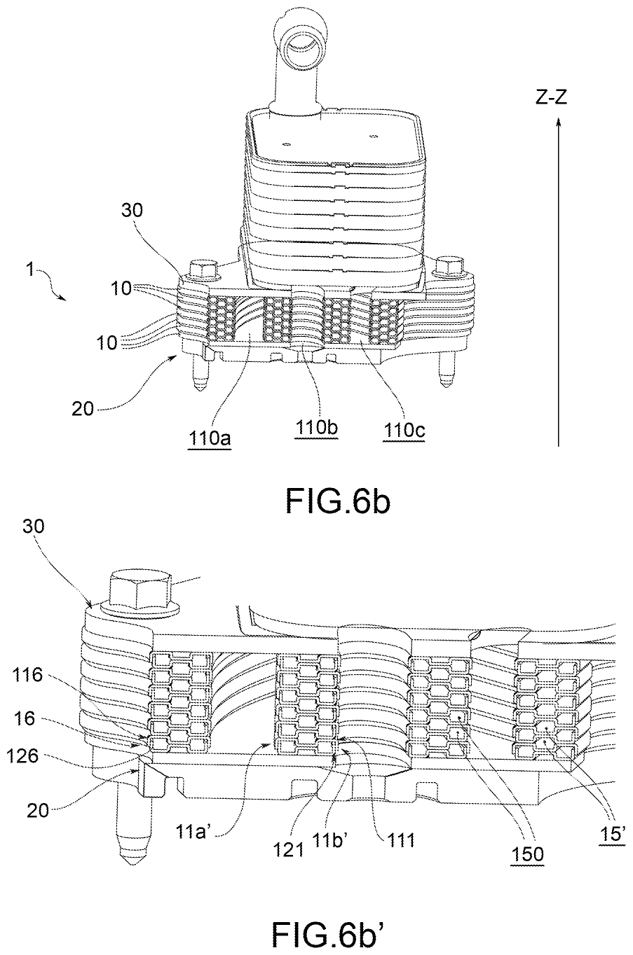

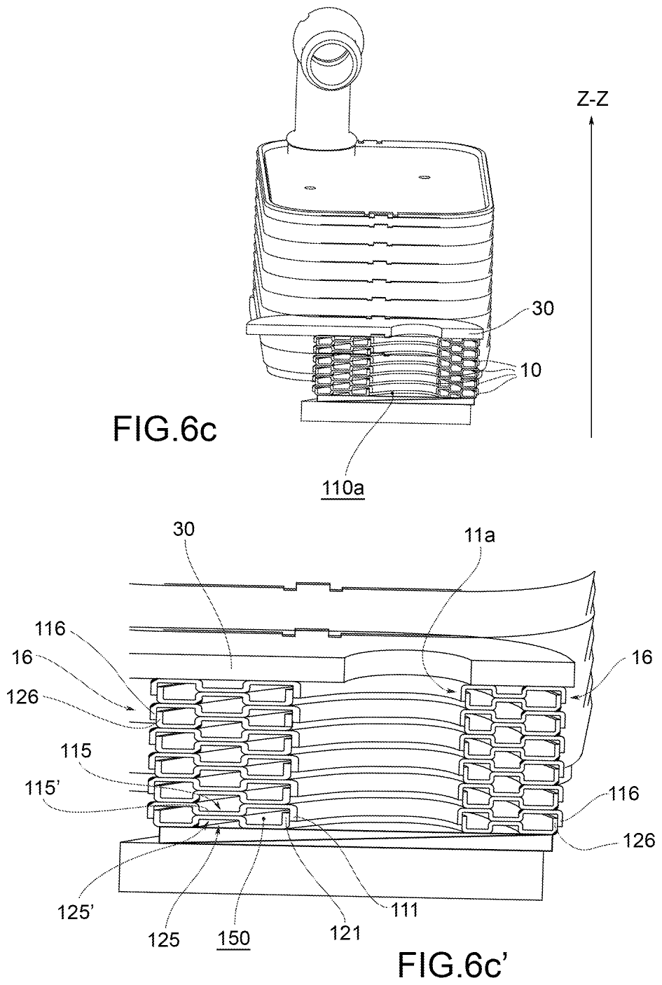

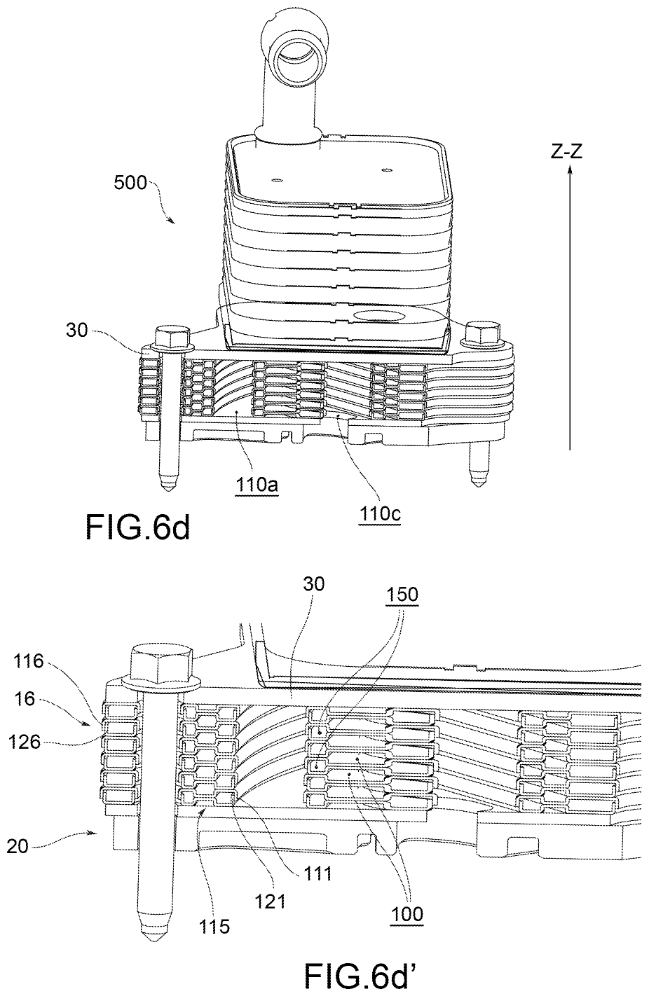

### DETAILED DESCRIPTION

With reference to the attached figures, number 1 indicates a support and connection device in accordance with this invention.

The support and connection device 1 is suitable as part of an operating group 900 of a vehicle.

Said operating group 900, which in turn is the subject of this invention, includes the support and connection device 1 and an operating device 500.

In accordance with a preferred embodiment, the operating device 500 is a device for regulating temperature. In accordance with a preferred construction variant, the operating device 500 is a filtering device. In accordance with a further preferred embodiment variant, the operating device 500 is a pump device. In accordance with a further preferred embodiment variant, the operating device 500 is a valve unit (such as for example a thermostatic valve). In other words, the operating device 500 is suitable for receiving a predefined quantity of working fluid (e.g. a predefined quantity of oil) and is suitable for carrying out an action and/or operation thereon.

According to a further preferred embodiment variant, the operating device 500 comprises both the heat regulation device (heat exchanger) and the filtration device, e.g. filtering element. Preferably, the filtration device is suitable to filter the oil coming from the functional group of the vehicle and circulating in the operating group 900.

In the attached figures, the operating device 500 is a device for regulating temperature, in particular a heat exchanger. Preferably, the operating device 500 is an oil/water plate-fin heat exchanger.

According to this invention, the operating group 900 is suitable for connection to a functional group of the vehicle, such as an engine group, or a transmission group or gearshift group. In particular, the support and connection device 1, subject of this invention, is suitable to engage and connect in fluidic terms the functional group with the operating device 500. Preferably the term “engine group” is understood to mean both the engine block of an internal combustion engine or the engine block of an electric or hybrid vehicle. In addition, preferably, the term “functional group” is understood to mean a complex system which integrates a plurality of functions such as for example the transmission systems installed on electric vehicles (such as for example the “e-axle” transmission system).

In accordance with a preferred embodiment, the support and connection device 1, moreover, also links in fluidic terms the operating group with an auxiliary operating device which is, in turn, included in the vehicle. For example, the support and connection device 1 supports a hydraulic connector which connects the vehicle group 900 with an auxiliary operating device (such as for example a turbo-charger), in which said hydraulic connector communicates with a fluidic passage mouth and/or a conduit for fluid passage created in said support and connection device (such as for example the fluid passage conduit 100d, shown in the attached figures, and described below).

In accordance with this invention, the support and connection device 1 identifies a vertical axis Z-Z and two longitudinal axes X-X; Y-Y set reciprocally at right angles on the same plane orthogonal to said vertical axis Z-Z. In particular, the support and connection device 1 extends in height parallel to the vertical axis Z-Z. Preferably, in this text, when referring to planar components reference is made to components substantially parallel to said plane orthogonal to the vertical axis Z-Z.

According to this invention, the support and connection device 1 includes at least one plate-shaped unit 10.

Preferably, the support and connection device 1 includes a plurality of plate-shaped units 10 reciprocally stacked along the vertical axis Z-Z.

In accordance with this invention each plate-shaped unit 10 has a substantially planar form, with an axial dimension of thickness, but above all extending longitudinally, parallel to the longitudinal axes X-X and Y-Y.

In accordance with this invention, in the plate-shaped unit 10 there is, in a vertical direction, at least one fluid passage mouth 11a; 11b; 11c; 11d that is traversable by a working fluid. In other words, the plate-shaped unit 10 includes at least one fluidic passage mouth 11a; 11b; 11c; 11d, with extension parallel to the vertical axis Z-Z.

Moreover, according to this invention, said fluid passage mouth 11a; 11b; 11c; 11d is defined laterally by a fluid passage mouth wall 11a′; 11b′; 11c′; 11d′.

It should be noted that the number and form of said mouths 11a; 11b; 11c; 11d, and in particular of the respective walls 11a′; 11b′; 11c′; 11d′ do not in any way limit the subject of this invention. As shown by way of example in the attached figures, each plate-shaped unit 10 includes a plurality of fluid passage mouths 11a; 11b; 11c; 11d. Moreover, preferably, each fluid passage mouth 11a; 11b; 11c; 11d has a different form than the other, not necessarily regular.

Preferably, in the stacking along the vertical axis Z-Z of a plurality of plate-shaped units 10, the respective fluid passage mouths 11a; 11b; 11c; 11d are aligned vertically and define respective fluid passage conduits 110a; 110b; 110c; 110d. Preferably, in function of the form of the respective mouths, fluid passage conduits are defined. Said fluid passage conduits 110a; 110b; 110c; 110d in function of the respective fluid mouths 11a; 11b; 11c; 11d on the respective plate-shaped units 10 have therefore a form and trajectory not necessarily parallel to the vertical axis and/or the longitudinal axes. In other words, in function of the position of the respective mouths 11a; 11b; 11c; 11d fluid passage conduits are defined (110a; 110b; 110c; 110d) of a form and trajectory such as to connect fluid inlets and outlets not necessarily aligned in a vertical direction and/or only partially overlaid in a vertical direction.

According to a preferred embodiment, the at least one plate-shaped unit 10 includes in vertical direction at least one blocking hole 18a; 18b; 18c; 18d traversable by blocking elements such as, for example, a bolt, a rivet, a pin, or by elements of reinforcement such as for example a bush.

Preferably, the plurality of plate-shaped units 10 reciprocally stacked along the vertical axis Z-Z define, aligning vertically the respective blocking holes 18a; 18b; 18c; 18d, specific blocking passages 180a; 180b; 180c; 180d parallel to the vertical axis Z-Z.

Preferably, each blocking hole 18a; 18b; 18c; 18d is defined laterally by a blocking hole wall 18a′; 18b′; 18c′; 18d′.

In the solutions as per the attached figures there are, not in limitative terms, four blocking holes for each plate-shaped unit 10.

In accordance with this invention, the plate-shaped unit 10 includes an upper laminar element 110 and a lower laminar element 120, reciprocally stacked along vertical axis Z-Z. Moreover, the plate-shaped unit 10 includes a hollow space 100 delimited between the upper laminar element 110 and lower laminar element 120.

In other words, through coupling of the upper laminar element 110 and lower laminar element 120 a plate-shaped unit 10 is constituted, which is to say a structural component. According to this invention, said structural element is hollow, the interior being a hollow space 100.

In accordance with this invention, said at least one fluid passage mouth 11a; 11b; 11c; 11d is defined laterally by a fluid passage mouth wall 11a′; 11b′; 11c′; 11d′ which is constituted by the reciprocal engagement of an upper mouth rim 111, included in the upper laminar element 110, and a lower mouth rim 121 included in the lower laminar element 120.

According to a preferred embodiment, in the stacking between the upper laminar element 110 and lower laminar element 120, the upper mouth rim 111 and lower mouth rim 121 overlap at least in part.

Preferably, the upper mouth rim 111 and lower mouth rim 121 extend for an axial section parallel to the vertical axis Z-Z.

In accordance with a preferred embodiment, in the stacking between the upper laminar element 110 and lower element 120, the respective upper mouth rims 111 and the respective lower mouth rims 121 overlap at least in part, preferably in a vertical direction. Preferably, the upper mouth rim 111 and the lower mouth rim 121 are in contact in correspondence at coupling points set on an imaginary plane parallel to the vertical axis Z-Z.

In accordance with a preferred embodiment, in the stacking between upper laminar element 110 and lower element 120, the respective upper mouth rims 111 and lower mouth rims 121 extend in a vertical direction and are reciprocally in contact at horizontal coupling points set on an imaginary plane orthogonal to the vertical axis Z-Z.

According to a preferred embodiment, in the stacking between the upper laminar element 110 and lower laminar element 120, the respective upper mouth rims 111 and lower mouth rims 121 extend in a horizontal direction and are reciprocally in contact at horizontal coupling points set on an imaginary plane orthogonal to the vertical axis Z-Z.

According to a preferred embodiment, in the stacking between the upper laminar element 110 and lower laminar element 120, the respective upper mouth rims 111 and lower mouth rims 121 extend in a vertical direction and are in contact at coupling points set on an imaginary plane parallel to the vertical axis Z-Z on several passage mouths 11a, 11b, 11c, 11d while extending in a horizontal direction and reciprocally in contact at horizontal coupling points set on an imaginary plane orthogonal to the vertical axis Z-Z on the remaining passage mouths 11a, 11b, 11c, 11d comprised in said plate-shaped unit 10.

In accordance with a preferred embodiment, moreover, the plate-shaped unit 10 in a zone proximal and perimetric to the at least one fluidic passage mouth 11a; 11b; 11c; 11d includes a reinforcing collar 15.

Preferably, the reinforcing collar 15 is suitable for reinforcing the zone proximal to the respective fluid passage mouth 11a; 11b; 11c; 11d.

In accordance with a preferred embodiment, in correspondence with said reinforcing collar 15, the upper laminar element 110 and the lower laminar element 120 are mutually engaged.

Preferably, the reinforcing collar 15 includes an upper reinforcing step 115, included in the upper laminar element 110, protruding in a vertical direction, preferably towards the lower laminar element 120. In accordance with a preferred embodiment, the upper reinforcing step 115, included in the upper laminar element 110, engages the lower laminar element 120.

Preferably, the reinforcement collar 15 includes a lower reinforcing step 125, included in the lower laminar element 120, protruding in the vertical direction, preferably towards the upper laminar element 110. In accordance with a preferred embodiment, the lower reinforcing step 125, included in the lower laminar element 120, engages the upper laminar element 110.

Preferably, in an embodiment including both the upper reinforcing step 115 and the lower reinforcing step 125, one engages the other.

According to a preferred embodiment, the upper reinforcing step 115 has an upper planar abutment wall 115′ engaging tight the lower laminar element 120 (in particular engaging tight the lower reinforcing step 125).

According to a preferred embodiment, the lower reinforcing step 125 has a lower planar abutment wall 125′ engaging tight the upper laminar element 110 (in particular engaging tight the upper reinforcing step 115).

In accordance with a preferred embodiment, between the upper mouth rim 111 and the upper reinforcing step 115 and/or between the lower mouth rim 121 and the lower reinforcing step 125 there is, in the hollow space 100, a reinforcement and sealing chamber 150. In other words, in a plate-shaped unit 10 between a fluid passage mouth and the respective reinforcing collar there is a reinforcement and sealing chamber 150 having the purpose of reinforcing the structure of the unit in proximity to the mouths. In addition, said reinforcement and sealing chamber 150 is suitable for defining a space suitable for containing any leaks of working fluid between the mouth rims.

In accordance with a preferred embodiment, said reinforcement chamber is in fluidic separation from the rest of the hollow space 100. In other words, the reinforcement chamber 150 defines a single volume in itself.

In this way, in the plate-shaped unit 10 a double sealing zone is created, suitable for avoiding leaks of working fluid towards the hollow space and/or towards the exterior. According to a preferred embodiment, then, the working fluid that flows into the fluid passage mouth 11a; 11b; 11c; 11d meets a first barrier due to the presence of the fluid passage mouth wall 11a′; 11b′; 11c′; 11d′, consisting of the upper mouth rim 111 and the lower mouth rim 121, and a second barrier due to the reinforcing collar 15, for example due presence of the upper reinforcement step 115 and/or the lower reinforcement step 125; wherein said barriers are separated by the reinforcement and sealing chamber 150.

In other words, the reinforcement and sealing chamber 150 is suitable to perform an isolation or barrier between a respective fluid passage mouth and the hollow space 100, in the case in which there is a leak between the upper mouth rim 111 and the lower mouth rim 121.

In particular, in the case of several fluidic passage mouths 11a; 11b; 11c; 11d, around each one of them is a reinforcement and sealing chamber 150.

In other words, in each plate-shaped unit 10, around each conduit 100a, 100b, 100c, 100d, there is a reinforcement and sealing chamber 150.

Preferably, but not necessarily, also in proximity to the blocking holes, the plate-shaped unit 10 includes rims or reinforcement collars, substantially analogous to those described above.

According to a preferred embodiment, the upper laminar element 110 includes at least one upper protrusion engaging the lower laminar element 120 and/or the lower laminar element 120 comprises at least one lower protrusion engaging the upper laminar element 110.

According to a preferred embodiment, the upper laminar element 110 comprises a plurality of upper protruding elements suitable to engage corresponding lower protruding elements comprised in the lower laminar element 120.

Preferably, the presence of said protrusions structurally reinforces the structure of the plate-shaped unit 10.

In accordance with a preferred embodiment, the hollow space 100 is externally open at the perimeter. In other words, between an upper laminar element 110 and a lower laminar element 120 there is airflow. In particular, said hollow space 100 may be employed for circulation of another fluid (e.g. air) usable for heat regulation of the fluids circulating in the operating group 900.

In accordance with an embodiment variant, the plate-shaped unit 10 includes an external perimeter wall 16 defined by the reciprocal engagement of an upper perimeter rim 116 included in the upper laminar element 110 and by a lower perimeter rim 126 included in the lower laminar element 120. Preferably, therefore, the hollow space 100 is externally closed at the perimeter by said external perimeter wall 16.

In accordance with a preferred embodiment, in the stacking between the upper laminar element 110 and lower laminar element 120, the upper perimeter rim 116 and lower perimeter rim 126 overlap at least in part. Preferably, the upper perimeter rim 116 and lower perimeter rim 126 engage reciprocally in the manner described above, in accordance with which the upper mouth rim 111 and lower mouth rim 121 are reciprocally engaged.

In accordance with a first embodiment, in said hollow space 100, closed, there is air. In other words, such hollow space 100 is not suitable for the circulation of a fluid.

In accordance with a further embodiment, in said hollow space 100, closed, a second working fluid circulates.

In accordance with a preferred embodiment, in the case of several stacked plate-shaped units 10, each hollow space 100 is such in itself, separate from the others.

In accordance with an embodiment variant, in the case of several stacked plate-shaped units 10, the hollow spaces 100 are interconnected for fluids. Preferably, therefore, in these hollow spaces 100 a second working fluid circulates (e.g. water or coolant from the vehicle cooling system).

Preferably, the support and connection device 1 operates in turn as a heat regulating device (i.e. heat exchanger) inasmuch as the working fluid circulating in the support and connection device exchanges heat with the air or second working fluid circulating in hollow space 100 defined by the lower and upper laminar elements and/or by the hollow spaces 100 defined by the stacking of a plurality of plate-shaped units 10. Preferably, in said hollow space(s) 100 one or more filling elements (or a turbulator element), suitable for rendering homogenous the flow of the second working fluid within it and/or to further increase the structural resistance of the support and connection device 1, are housable.

According to a preferred embodiment, the upper laminar element 110 and the lower laminar element 120, of a plate-shaped unit 10, are in metal and are joined together by brazing.

Preferably, the upper laminar element 110 and the lower laminar element 120 are obtained from sheets of material that has been specifically processed, such as for example operations of cutting and of plastic deformation. Preferably, for example, the abovementioned collars and/or steps are obtained by operations of plastic deformation, for example with a single operation all the collars and/or steps surrounding the plurality of openings are obtained. Preferably, in some embodiments a collar and/or step extends with continuity around more than one mouth.

Preferably, the upper laminar element 110 and lower laminar element 120 have a thickness between 0.4 mm and 2 mm, preferably between 0.4 mm and 1.2 mm.

Preferably, the operating device 500 is manufactured in a metal material and is joined to the support and connection device 1 by brazing or welding. Preferably, the operating device 500 and support and connection device 1 are joined by brazing in a single run in autoclave.

Preferably, the operating device 500 is manufactured in a metal material and joined to the support and connection device 1 by bonding.

Preferably, the operating device 500 is manufactured in plastic material and is joined to the support and connection device 1 by bolts or rivets.

In accordance with this invention, support and connection device 1 includes a base body 20, solid and preferably plate-shaped, on which the at least one plate-shaped unit 10 is vertically stacked.

Preferably, said base body 20 is positioned on the side opposite to the operating device 500. Preferably, the base body 20 is suitable for engaging a respective vehicle group on which the operating group 900 may be mounted.

In accordance with a preferred embodiment, the support and connection device 1 includes a head body 30, solid and preferably plate-shaped, on which the operating device 500 may be mounted.

Preferably, the at least one plate-shaped unit 10 is sandwiched between the base body 20 and head body 30.

Preferably, a plurality of plate-shaped units 10 are sandwiched between the base body 20 and head body 30.

Preferably, the head body 30 and/or base body 20 is made of metal. Preferably the head body 30 and/or the base body is joined to the support and connection device 1 by brazing.

Preferably, the head body 30, base body 20, support and connection device 1 and operating device 500 are in metal and are joined with brazing in a single run, preferably in a single brazing process in the autoclave.

According to this preferred embodiment, the base body 20 and, if required, head body 30 include inlet and/or outlet apertures connected in fluidic terms with the at least one fluid passage mouth 11a; 11b; 11c; 11d.

Preferably, the base body 20 and, if required, head body 30 are also equipped with gasket elements, such as the lower gasket 29.

According to a further preferred embodiment, the gasket 29 is positioned within a gasket slot formed integrally on the external side of a plate-shaped unit 10 included in the support and connection device 1 and facing respectively the operating device 500 or the fixing surface provided on the engine group, the transmission group or the gearshift group.

Other embodiments are possible wherein, for example, two consecutive plate-shaped units 10 are suitable for defining specific further auxiliary hollow spaces which can be exploited as needed.

For example, in a preferred embodiment, in a zone perimetric and proximal to the respective fluid passage mouths 11a; 11b; 11c; 11d, two axially consecutive plate-shaped units 10 define an auxiliary reinforcement and sealing chamber 15′ having the same purposes as the reinforcement and sealing chamber 15 described above.

Innovatively, the support and connection device and the operating group that includes it amply fulfill the purpose of this invention by overcoming the typical problems of the prior art.

Advantageously, in fact, the support and connection device resolves the problem of weight found in state of the art solutions.

Advantageously, occupying the same space as a support and connection device solution found in the state of the art, this support and connection device has a greater percentage of free volume, with consequent advantages in terms of weight.

Advantageously, the support and connection device allows a reduction in weight of vehicles it is mounted on—be it a vehicle powered by internal combustion engine, electric motor or a hybrid vehicle. Advantageously, the support and connection device allows a reduction in fuel consumption (or residual electric charge of the batteries) for vehicles in which it is installed.

Advantageously, occupying the same space, the support and connection device allows a reduction in weight of the operating group of up to one-third in comparison with the prior solutions in which the support and connection device consists of stacking a series of planar elements at constant thickness, usually between 2 and 3 mm.

Advantageously, occupying the same space, the support and connection device allows a reduction in weight of the operating group of up to one-third in comparison with the prior solutions in which the support and connection device consists of an aluminium alloy body made using a casting process.

Advantageously, the support and connection device allows a reduction in the quantity of material used and consequently a reduction in production costs.

Advantageously, moreover, the support and connection device resolves the problem of bulk found in state of the art solutions.

Advantageously, the support and connection device optimises the exploitation of available installation space in the vehicle. Especially in the engine compartment or at the fixing surface of the functional group on which it is assembled. Advantageously, moreover, the support and connection device is simple and inexpensive to produce.

Advantageously, the support and connection device is utilisable as another heat exchanger, properly exploiting the “hollow space” between the two laminar elements and/or the “hollow spaces” delimited by the plate-shaped units that comprise it.

Advantageously, the support and connection device is utilisable in turn as a heat regulation device (heat exchanger) wherein the working fluid circulating in the support and connection device exchanges heat with the air circulating in the open spaces provided around the fluid passages defined by the lower laminar element and upper laminar element and/or by the stacking of the plate-shaped units. Analogously, advantageously, the support and connection device is utilisable in turn as a heat regulation device (heat exchanger) wherein the working fluid circulating in the support and connection device exchanges heat with the liquid circulating in the hollow space defined by the lower laminar element and the upper laminar element and/or by the hollow spaces defined by the stacking of the plate-shaped units.

Advantageously, by means of the support and connection device, it is therefore possible to create a lightweight integrated heat regulation module. Advantageously, through appropriate sizing of the support and connection device, and in particular through the choice of the appropriate number of plate-shaped units, the desired power of said integrated heat regulation module is achievable. Advantageously, by inserting special components in the hollow spaces, turbulators or dissipating elements, an increase in the heat exchange area and therefore of thermal power is achievable.

Advantageously, in the configuration in which the operating device is a fin-plate water/oil heat exchanger, the operating device is partially housable in the connection and support device. In other words, advantageously, occupying the same space, the support and connection device allows the extension of the heat exchanger in the same device, increasing the thermal power from the operating group. Advantageously, the support and connection device is extremely versatile and outstandingly flexible.

Clearly, a person skilled in the art, to meet contingent needs, could carry out modifications to the oil temperature regulation group described above, within the scope of protection as defined by the following claims.

### LIST OF REFERENCE NUMBERS

1 support and connection device
10 plate-shaped unit
11a; 11b; 11c; 11d fluidic passage mouth
11a′; 11b′; 11c′; 11d′ fluidic passage mouth wall
15 reinforcing collar
15′ auxiliary reinforcement and sealing chamber
16 external perimeter wall
18a; 18b; 18c; 18d blocking holes
18a′, 18b′, 18c′, 18d′ blocking hole walls
110 upper laminar element
111 upper mouth rim
115 upper reinforcement step
115′ upper planar abutment wall
116 upper perimeter rim
120 lower laminar element
121 lower mouth rim
125 lower reinforcement step
125′ lower planar abutment wall
126 lower perimeter rim
100 hollow space
150 reinforcement and sealing chamber
110a; 110b; 110c; 110d fluid passage conduits
180a; 180b; 180c; 180d blocking passages
20 base body
29 gasket elements
30 head body
500 operating device
900 operating group
X-X, Y-Y longitudinal axes
Z-Z vertical axis

1. A support and connection device of an operating group of a vehicle, connectable to a functional group of the vehicle comprising an engine group or a transmission group or a gearshift group, in which the support and connection device is configured for fluidly supporting and connecting to said functional group an operating device, comprising a temperature regulation device or a filtration device or a pump device, in turn comprised in said operating group, wherein the supporting and connecting device identifies a vertical axis and two longitudinal axes and comprises at least one plate-shaped unit in which at least one fluid passage mouth is formed in the vertical direction traversable by a working fluid;
wherein the plate-shaped unit comprises an upper laminar element, a lower laminar element mutually stacked along the vertical axis and a hollow space delimited between the upper laminar element and the lower laminar element;
wherein said at least one fluid passage mouth is defined laterally by a fluid passage mouth wall comprising mutual engagement of an upper mouth rim included in the upper laminar element and of a lower mouth rim included in the lower laminar element.

2. A support and connection device according to claim 1, wherein, in stacking between the upper laminar element and the lower laminar element, the upper mouth rim and the lower mouth rim overlap at least in part.

3. A support and connection device according to claim 1, wherein the plate-shaped unit in a proximal and perimetric region to the fluid passage mouth comprises a reinforcing collar comprising an upper reinforcing step, part of the upper laminar element, projecting in a vertical direction and/or a lower reinforcing step, part of the lower laminar element, projecting in a vertical direction, wherein in said reinforcing collar the upper laminar element and the lower laminar element are mutually engaged.

4. A support and connection device according to claim 3, wherein the upper reinforcing step has an upper planar abutment wall engaging tight the lower laminar element and/or the lower step has a lower planar abutment wall engaging tight the upper laminar element.

5. A support and connection device according to claim 3, wherein the plate-shaped unit comprises a reinforcement and sealing chamber defined in the hollow space, between the upper mouth rim and the upper reinforcement step and/or between the lower mouth rim and the lower reinforcement step.

6. A support and connection device according to claim 1, wherein the upper laminar element comprises at least one upper protruding element engaging the lower laminar element and/or the lower laminar element comprises at least one lower protruding element engaging the upper laminar element.

7. A support and connection device according to claim 1, wherein a second working fluid circulates in the hollow space.

8. A support and connection device according to claim 1, wherein the hollow space is externally perimetrically open.

9. A support and connection device according to claim 1, wherein the plate-shaped unit comprises an external perimeter wall defined by the mutual engagement of an upper perimeter rim included in the upper laminar element and a lower perimeter rim included in the lower laminar element, wherein said hollow space is externally perimetrically closed by said external perimeter wall.

10. A support and connection device according to claim 9, wherein, in stacking between the upper laminar element and the lower laminar element, the upper perimeter rim and the lower perimeter rim overlap at least in part.

11. A support and connection device according to claim 1, comprising a plurality of plate-shaped units reciprocally stacked along the vertical axis to vertically align the respective fluid passage mouths defining respective fluid passage conduits.

12. A support and connection device according to claim 11, wherein in a region perimetric and proximal to the respective fluid passage mouths, two axially consecutive plate-shaped units define an auxiliary reinforcement and sealing chamber.

13. A support and connection device according to claim 1, wherein at least one plate-shaped unit comprises in the vertical direction at least one blocking hole traversable by blocking and reinforcing elements.

14. A support and connection device according to claim 12, wherein the plurality of plate-shaped units reciprocally stacked along the vertical axis defines by vertically aligning the respective blocking holes specially designed blocking passages, extending parallel to the vertical axis.

15. A support and connection device according to claim 1, wherein the upper laminar element and the lower laminar element of a plate-shaped unit are made of metal and are mutually joined by brazing.

16. A support and connection device according to claim 1, comprising a solid base body on which the at least one plate-shaped unit is vertically stacked, wherein said base body is positioned on an opposite side with respect to the operating device.

17. A support and connection device according to claim 16, comprising a solid head body, on which the operating device is mountable, wherein the at least one plate-shaped unit is sandwiched between the base body and the head body.

18. A support and connection device according to claim 16, wherein the base body and the head body comprise inlet and/or outlet openings fluidly connected with the at least one fluid passage mouth.

19. An operating group of a vehicle comprising a device for regulating temperature and a support and connection device according to claim 1, wherein the support and connection device is fluidly connectable to one or more fluid circuits of the vehicle, through which, oil or water flows.

20. An operating group of a vehicle comprising a filtration device and a support and connection device according to claim 1, wherein the support and connection device is fluidly connectable to one or more vehicle oil circuits comprising the oil circuit of the engine group and/or the gearshift group and/or the transmission group and/or the turbo-charger.

21. A support and connection device according to claim 16, wherein the base body is plate-shaped.

22. A support and connection device according to claim 17, wherein the base body is plate-shaped.
